(19) United States
(12) Patent Application Publication
(10) Pub. No.: US 2005/0225805 A1
(43) Pub. Date: Oct. 13, 2005

(54) Image forming apparatus, program therefor, storage medium, and image forming method

(75) Inventor: Masahiro Kato, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 11/067,987

(22) Filed: Mar. 1, 2005

(30) Foreign Application Priority Data
Apr. 13, 2004 (JP) 2004-118248

(51) Int. Cl. G06K 15/02; H04N 1/387; G06K 9/34

(52) U.S. Cl. 358/1.18; 382/173

(57) ABSTRACT

The image forming apparatus comprises a processing part that performs a predetermined processing of image data. An image splitting part generates split image data expressing two horizontally or vertically split images of the image expressed by manuscript image data. A component extraction part analyzes a layout of an image expressed by the manuscript image data, and extracts a component of the image. A controller, when a command is inputted to separately form images of horizontally or vertically juxtaposed pages of a spread manuscript, if the component is allocated to span the horizontally or vertically juxtaposed pages, supplies the manuscript image data to the image processor without splitting. If the component is not allocated to span the horizontally or is vertically juxtaposed pages, the controller supplies the manuscript image data to the image splitting part.

### BACKGROUND OF THE INVENTION

1. Field of the Invention

The present invention is related to an image forming apparatus capable of separately forming images for horizontally or vertically juxtaposed pages of a spread manuscript.

2. Description of the Related Art

Some conventional copy machines are known to have a so-called “continuous page copying” function which makes it possible to provide copies of images for horizontally or vertically juxtaposed pages of a spread manuscript, or to generate and store (hereinafter called “to scan”) image data of the respective pages. In the continuous page copying function, the copying machine horizontally or vertically splits a retrieved image of the spread manuscript and the split images are printed on separate sheets. Or if the machine has a scanning function, it generates and stores image data expressing the split images.

However, in some cases, a layout of the spread manuscript includes a flock of texts or graphics (hereinafter called “component(s)”) spanning both of the horizontally or vertically juxtaposed pages. If such a layout is copied or scanned using the continuous page copying function, the component is split and the content of the component will be difficult to comprehend.

Some copy machines are known to display an image before it is copied so that the operator can visually confirm the image. For example, it is known to provide a technique which makes it possible to display several images in a printing order before printing those images using the continuous page copying function or the like. Using this technique, the operator can confirm that the images are printed in a preferred order.

However, if the layout includes a component spanning both of the horizontally or vertically juxtaposed pages of a spread manuscript, it is necessary to perform extra operations of the copy machine to have desired images printed.

### SUMMARY OF THE INVENTION

The present invention is established in view of the above described background, and provides a technique for an image forming apparatus having a continuous page copying function, which separately forms images of the horizontally or vertically juxtaposed pages of a spread manuscript, is capable of printing images or storing data of the images even when the layout includes a component spanning the horizontally or vertically juxtaposed pages of the spread manuscript.

To address the stated problems, the present invention provides an image forming apparatus furnished with: an image reading part that reads a manuscript and generating manuscript image data; a processing part that performs a predetermined processing of image data; a command input part that inputs a command; an image splitting part that generates split image data expressing two horizontally or vertically split images of the image expressed by the manuscript image data, and supplying the split image data to the processing part; a component extraction part that analyzes a layout of an image expressed by the manuscript image data, and extracting a component of the image; and a continuous copying method decision part that, when a command is inputted through the command input part to separately form images of horizontally or vertically juxtaposed pages of a spread manuscript, judges if there is a component, among the components extracted by the component extraction part, which is allocated to span the horizontally or vertically juxtaposed pages, wherein, if the judgment result is positive, the manuscript image data is supplied to the processing part without splitting, while, if the judgment result is negative, the manuscript image data is supplied to the image splitting part.

### BRIEF DESCRIPTION OF THE DRAWINGS

Embodiments of the present invention will be described in detail based on the following figures, wherein:

FIG. 1 illustrates a construction of the image forming apparatus according to the present invention;

FIG. 2 schematically illustrates a construction of the image processing part;

FIG. 3 illustrates a flowchart of processing performed by the CPU;

FIG. 4 schematically illustrates an example of a spread manuscript;

FIG. 5 schematically illustrates parameters used in a judgment made by the continuous copying method decision part;

FIG. 6 schematically illustrates another example of a spread manuscript;

FIG. 7 schematically illustrates another example of a spread manuscript; and

FIG. 8 schematically illustrates an example of a manuscript that can be safely spit.

### DETAILED DESCRIPTION OF THE INVENTION

An embodiment of the present invention will be described with reference to the attached drawings.

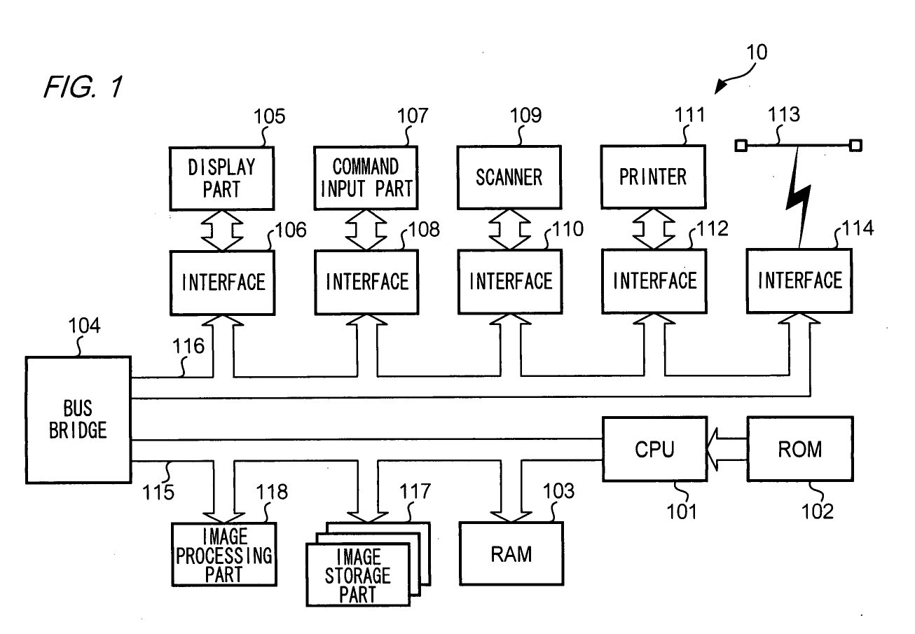

FIG. 1 illustrates a structure of an image forming apparatus 10 according to the present invention. A ROM (Read Only Memory) 102 is installed with a program or data used for controlling the image forming apparatus 10, and a CPU (Central Processing Unit) 101 is provided for controlling the performance of each part of image forming apparatus 10 by reading out the program stored in ROM 102, deploying it on a RAM (Random Access Memory) 103, and executing it. An image storage part 117 comprises, for example, a hard disk driver for storing therein image data or the like. Construction of an image processing part 118 will be described hereinafter. CPU 101, RAM 103, image storage part 117, and image processing part 118 are respectively connected to a bus 115 that enables high speed data transmission.

Various peripheral parts are connected to another bus 116. A display part 105 comprises, for example, a liquid crystal panel, CRT (Cathode Ray Tube), or the like, and displays operation menus or the like. A command input part 107 furnished with a keyboard, mouse, digitizer, or the like, is used for inputting commands for operating image forming apparatus 10. A scanner or image reading part 109 is provided for reading a manuscript and generating a multi-valued image data expressing a multiple gradation image. A printer (processing part) 111 forms images on a surface of a recording sheet based on the image data using an electrophotographic or ink jet technology. Display part 105, command input part 107, scanner 109, and printer 111 are connected to bus 116 through respective interfaces 106, 108, 110, 112. Bus 116 is also connected to a network 113 through the interface 114 so that image forming apparatus 10 can send and receive data to and from outside systems. These buses 115, 116 are mutually connected through a bus bridge 104.

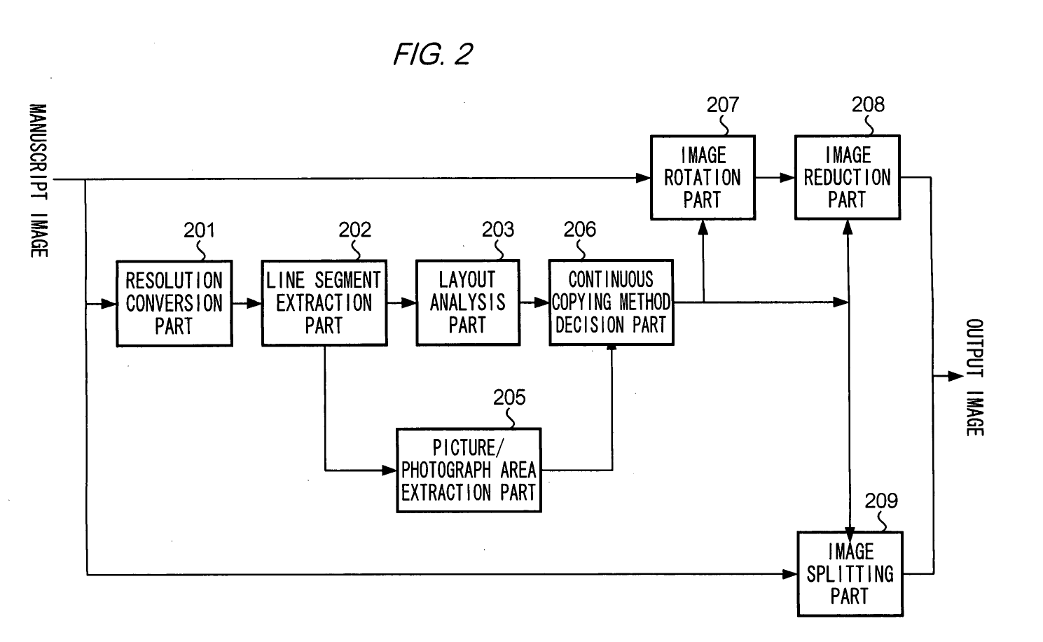

FIG. 2 illustrates the structure of image processing part 118. The parts described hereafter are modules virtually created by CPU 101 when executing a program.

A resolution conversion part 201 is provided for receiving the manuscript image data generated by scanner 109 and lowering the resolution of the manuscript image data to a minimum resolution level to maintain a necessary amount of information for performing a layout analysis at a layout analysis part 203 at later stages. By performing this resolution lowering process, the process at the later stages can be performed at a higher speed.

A line segment extraction part 202 is provided for extracting pixels constituting a line segment from the image data and generating a line segment image data. More specifically, line segment extraction part 202 receives the manuscript image data with a resolution lowered by resolution conversion part 201, and extracts pixels constituting the line segment from the manuscript image data. This extraction process will be schematically described hereinafter.

To start with, binarization of a multi-valued image is performed. In the binarization process, an average pixel value of the pixels contained in a predetermined range of area surrounding the target pixel is calculated first. Then, if the difference between the pixel value of the target pixel and the calculated average pixel value is equal to or larger than a predetermined threshold value, the pixel value for the target pixel is set as “1”, and if the difference is smaller than the threshold value, the pixel value for the target pixel is set as “0”. Since line segments construct components such as characters, line drawings or tables, a pixel value of the pixel constituting these components is clearly different from the pixels constituting the background components, in most cases. Meanwhile, photographs or pictures are constructed from pixels having various gradations so that the pixel value difference between the target pixel and the circumferential pixels is smaller. Therefore, by setting a proper threshold, it is possible to distinguish line segments from others such as photographs or pictures.

After performing this process for all the pixels, extraction of connected pixels is performed using a known labeling processing. In the extraction of the connected pixels, pixels constituting the binarized image data are sequentially scanned, and if a pixel having pixel value “1” is found, it is examined if another pixel having pixel value “1” exists in the vicinity of the target pixel, and the neighboring pixels having pixel value “1” are bestowed with the same labeling value.

Then a rectangle circumscribing the pixel group bestowed with the same label value is formed, and if the dimension of the circumscribing rectangle is equal to or smaller than a predetermined threshold, then the pixel value of the pixels constituting the pixel group is changed to “0”. This process eliminates noises.

In this embodiment, the pixel group bestowed with the same labeling value in the above-described manner is deemed as a line segment, and an image constructed by these line segments is called a line segment image. And an image data expressing the line segment image is called line segment image data.

The above-described method for extracting line segments is described in detail in the Japanese Laid-open Patent Publication 2002-175532, the content of which is herein incorporated by reference.

Layout analysis part 203 is provided for analyzing the layout of the line segment image expressed by the line segment image data, and categorizing the components of the line segment image into text areas furnished with character strings, drawing areas furnished with line drawings, and table area furnished with tables. In the present embodiment, a known layout analysis method is used. In the layout analysis, feature quantities, such as position, dimension, configuration, density, or projection distribution, of the connected pixels constituting the line segment image and extracted as described above, are measured, and the connected pixels are categorized under a rule prescribed by a predetermined threshold value or the like. The technique of the layout analysis is explained in detail, for example, in Japanese Laid-open Patent Publication H09-91450, the contents of which are herein incorporated by reference.

A picture/photograph area extraction part 205 is provided for generating a line segment eliminated image data by eliminating text areas, line drawing areas and table areas from the manuscript image data, and extracting a picture/photograph area furnished with a picture or photograph from the line segment eliminated image data. Here, the picture/photograph area is extracted using the same layout analysis method as in layout analysis part 203.

The above-described line segment extraction part 202, layout analysis part 203, and picture/photograph area extraction part 205 construct a component extraction part.

An image rotation part 207 is provided for generating an image data expressing an image formed by rotating the source image by 90 degrees.

An image reduction part 208 is provided for generating an image data expressing an image formed by reducing the source image to fit into a one-page area.

An image splitting part 209 is provided for generating split image data expressing images formed by horizontally or vertically splitting an image expressed by the manuscript image data that is generated by scanner 109, and for supplying the split image data to printer 111.

A continuous copying method decision part 206 is provided for deciding, when a command is inputted to perform so called “continuous page copying” for separately forming images of two horizontally or vertically juxtaposed pages of a spread manuscript, whether to perform lo continuous page copying or to form an image of the spread manuscript as a single image without performing continuous page copying, by judging if there is a component allocated to span the horizontally or vertically juxtaposed pages. More specifically, if there is a component spanning the horizontally or vertically juxtaposed pages, the part forms a target image as a single image by processing such as reducing the image with or without 90 degrees rotation. Meanwhile, if there is no component spanning the horizontally or vertically juxtaposed pages, the part separately forms images of the horizontally or vertically juxtaposed pages, by supplying the manuscript image data to image splitting part 209.

In the present embodiment, an additional judgment is performed using the following parameters. In some situations, the continuous page copying function can be safely applied even when a component is allocated to span the juxtaposed pages. FIG. 8 illustrates manuscript examples of such a situation. In the example illustrated in FIG. 8(a), a greater part of the component belongs to the right page, and only a small left edge part of the component belongs to the left page. If the component is a photograph or a picture, the horizontally juxtaposed pages can be split in most situations without any problems. In another example illustrated in FIG. 8(b), a ruled line is allocated to span a full width of the horizontally juxtaposed pages. This is another situation where the two pages can be split nearly always without problems. In the present embodiment, a judgment using the following parameters is made to safely form split images, in consideration of these situations, even when there is a component allocated to span horizontally or vertically juxtaposed pages.

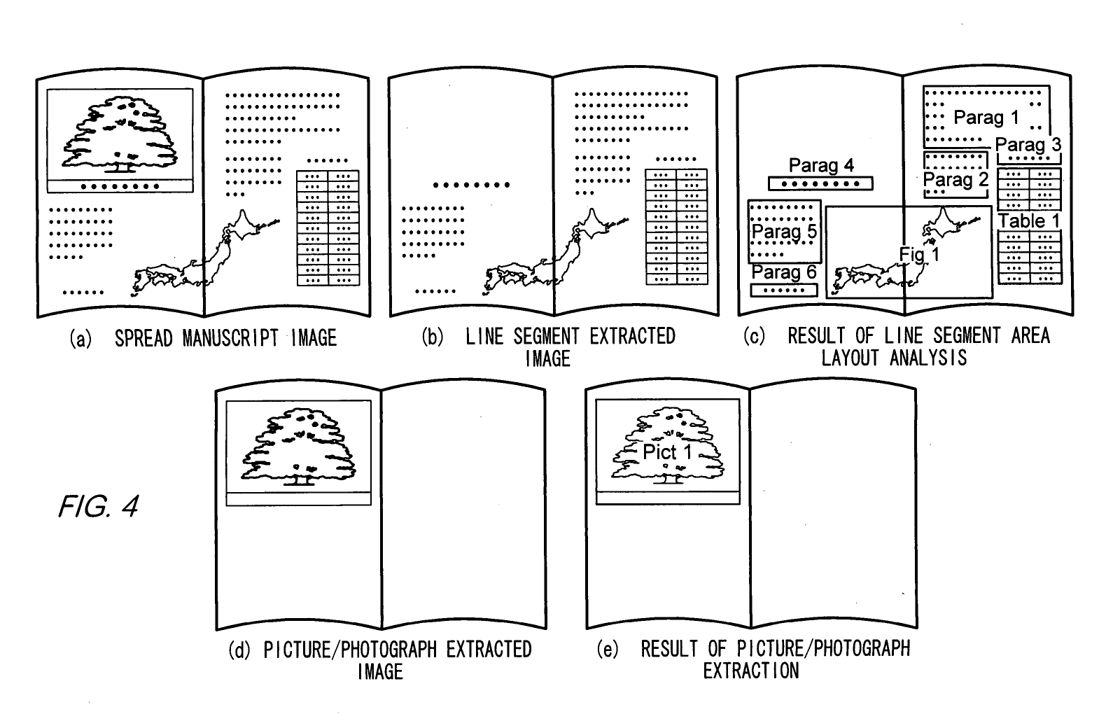

In the following, an example is described for a manuscript that is horizontally spread. FIG. 5 illustrates parameters used in the determination. “FIG. 1” is a component allocated to span horizontally juxtaposed pages. Here, page width is designated as “PW”, page height is designated as “PH”, component width is designated as “OW”, and component height is designated as “OH”. Also, width of a part of the component belonging to left page is designated as “OWL”, and width of a part of the component belonging to right page is designated as “OWR”.
OWL<PW×TH1, or OWR<PW×TH1 Parameter (1)
wherein TH1 is a threshold and, 0<TH1<1

Parameter (1) is intended to handle the situation illustrated in FIG. 8(a), and defines a ratio of the width of a part belonging to one of the pages relative to the page width. For example, when “TH1=0.1”, and if a ratio of the width of a part belonging to either page relative to the page width is less than 10%, then the continuous page copying function works to separately form images of the horizontally juxtaposed pages.
OWL<TH2, or OWR<TH2 Parameter (2)
wherein TH2 is a threshold and, 0<TH2<PW

Parameter (2) is also intended to handle the situation illustrated in FIG. 8(a), and defines the width of a part belonging to either page. Parameter (2) is different from Parameter (1) in defining by width values.
OH<TH3 Parameter (3)
wherein TH3 is a threshold and, 0<TH3<PH

Parameter (3) is intended to handle the situation illustrated in FIG. 8(b), and defines the height of the component. For example, when TH3=1 mm, and if the ruled line having a line width of less than 1 mm spans the juxtaposed pages, then the continuous page copying function works to separately form images of the horizontally juxtaposed pages.

Here, the threshold values TH1, TH2, and TH3 can be arbitrarily determined by a user according to the type of the manuscript or his or her preferences. It is also possible to use other parameters. Various parameters can be used such as, the one defining a ratio of width OWL (or OWR) relative to the component width OW.

When all of the parameters above are not satisfied, processing is performed for containing the horizontally juxtaposed pages of the spread manuscript within a single image without split.

When a command is inputted for forming a reduced image of the source image through command input part 107, an image data expressing an image formed by reducing the manuscript image to fit into a one-page area is generated using image reduction part 208, which is then supplied to printer 111.

Meanwhile, if a command is inputted through the command input part 107 to rotate the manuscript image by 90 degrees, an image data expressing an image formed by rotating the manuscript image by 90 degrees is generated using image rotation part 207, an image data expressing an image formed by reducing the 90 degrees rotated manuscript image to fit into a one-page area is generated using the image reduction part 208, which is then supplied to printer 141.

The operations of the above-constructed image forming apparatus 10 will be described hereinafter. Since CPU 101 performs the following operations through execution of a program, these operations are explained as actions of CPU 101.

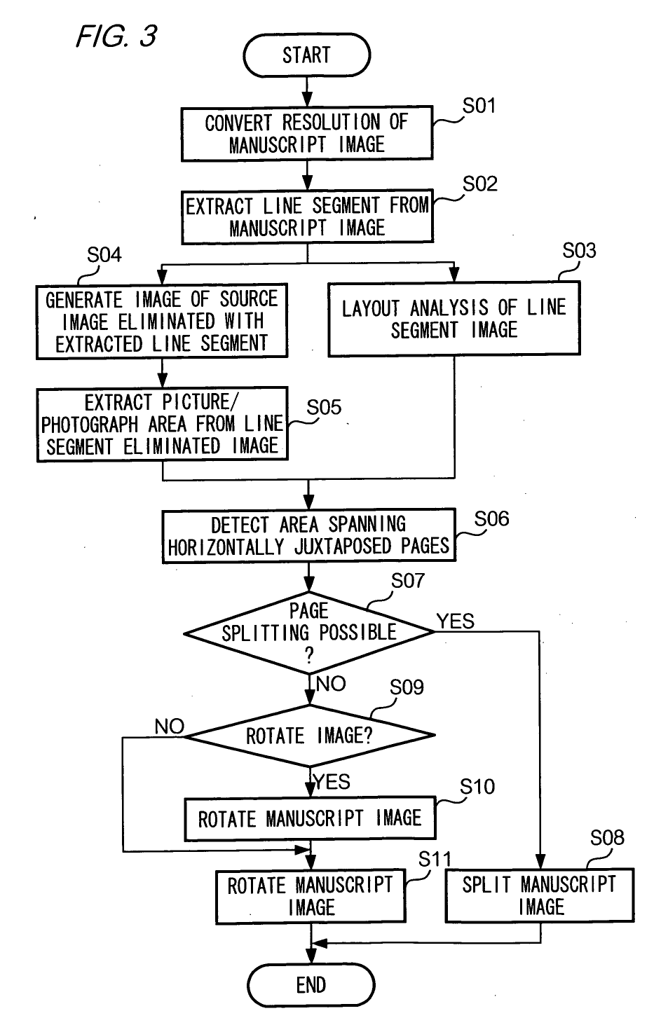

FIG. 3 is a flowchart of the processes performed by CPU 101. Here, it is assumed that a user has already inputted a command for performing continuous page copying through command input part 107, and scanner 109 has scanned a spread manuscript and generated the manuscript image data.

At the beginning, in step S01, CPU 101 converts resolution of the source image data generated by scanner 109 using resolution convert part 201. CPU 101 receives the manuscript image data generated by scanner 109 and lowers resolution of the manuscript image data to a minimum resolution enough to maintain necessary amount of information for executing the layout analysis in a layout analysis part 203 at a later stage. By executing this process, the following process can be performed at a higher speed.

FIG. 4(a) illustrates an example of an image of the spread manuscript. In this example, a photograph is allocated in the upper area of left page, a line drawing is in the lower area to span both right and left pages, and a table is allocated in the lower right area of right page. In other areas of these pages, multiple flocks of text are allocated.

In step S02, CPU 101 receives the manuscript image data, the resolution of which is lowered by resolution conversion part 201, and extracts pixels constituting a line segment from the manuscript image data and generates line segment image data using line segment extraction part 202. FIG. 4(b) is an example of a line segment image extracted through the above-described line segment extracting process. As illustrated in this figure, in the line segment image, a photograph allocated in the upper area of the right page is eliminated.

Then in step S03, CPU 101 analyzes the layout of line segment image expressed by the line segment image data, using layout analysis part 203, and categorizes the components of the line segment image into text areas furnished with character strings, drawing areas furnished with line drawings, and table areas furnished with tables.

FIG. 4(c) illustrates the result of the layout analysis of the line segment image. In the figure, “Parag 1”, “Parag 2”, “Parag 3”, “Parag 4”, “Parag 5”, and “Parag 6” are all the text areas. Among these, “Parag 3”, “Parag 4”, and “Parag 6” are captions for photographs or graphics, and such captions will also be categorized in text areas. “FIG. 1” is a line drawing area furnished with line drawings. “Table 1” is a table area furnished with a table.

In step S04, which is executed in parallel with step S03, CPU 101 generates a line segment-eliminated image data using picture/photograph area extraction part 205 by eliminating text areas, line drawing areas and table areas from the manuscript image data.

In step S05, CPU 101 extracts a picture/photograph area furnished with pictures or photographs from the line segment-eliminated image data. FIG. 4(d) illustrates an image furnished with the extracted picture/photograph area. FIG. 4(e) illustrates the result of extraction of the picture/photograph area. Here, the extracted photograph area is denoted as “Pict 1”.

In the processes following step S06, CPU 101 judges if there is a component allocated to span the horizontally juxtaposed pages using continuous copying method decision part 206, and depending on the judgment result, further decides if it performs continuous page copying or forms a single image of the juxtaposed pages without performing continuous page copying.

To start with, in step S06, CPU 101 extracts components allocated to span the horizontally juxtaposed pages among the text areas, line drawing areas, table areas, or picture/photograph areas extracted in steps S03 and S05.

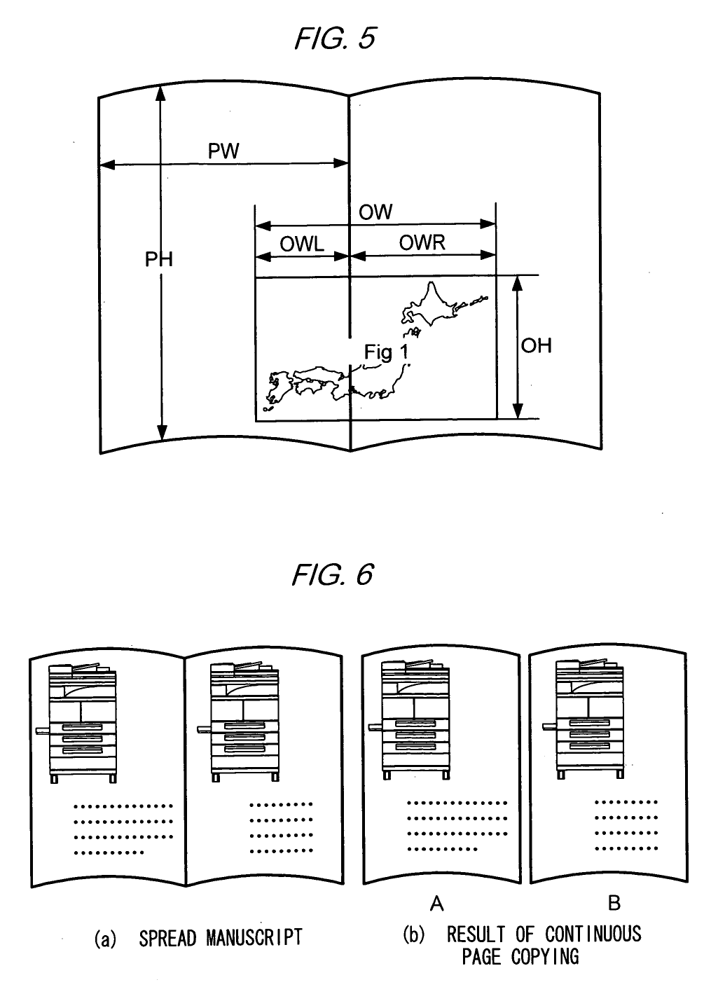

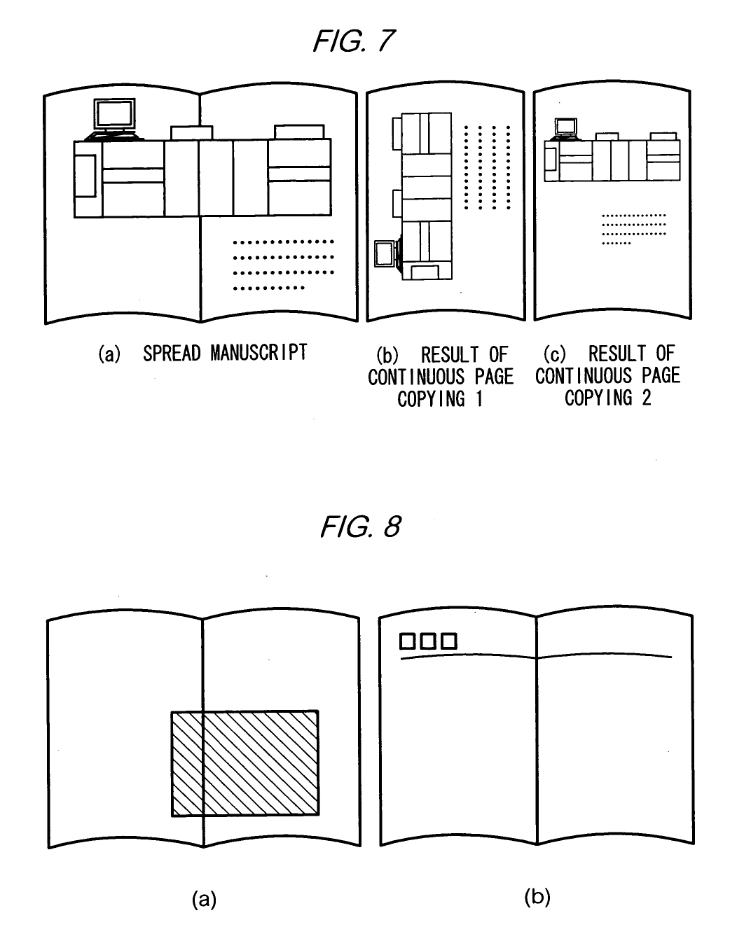

Then in step S07, CPU 101 decides if images of the horizontally juxtaposed pages are formed separately. In this process, it is judged if the extracted areas in step S06 satisfy any of the above-described parameters (1), (2), and (3). If the areas satisfy any of these parameters, the right and left pages can be formed separately (step S07: YES), leading up to step S08 so that the source image data is supplied to image splitting part 209. FIG. 6(a) illustrates another example of a spread manuscript. FIG. 6(b) illustrates horizontally split images separately formed by continuous page. copying. If none of the parameters (1) through (3) are satisfied, the page splitting process is not performed (S07: NO), and CPU 101 proceeds to step S09. FIG. 7(a) illustrates an example of a spread image for which the page splitting process is not performed.

In step S09, in response to an instruction from a user through display part 105 and command input part 107, CPU 101 generates an image data by rotating by 90 degrees the manuscript image data using image rotation part 207 (step S10). Meanwhile, if the user inputs a command not to rotate the image (step S09: NO), CPU 101 proceeds to step S11.

In step S11, CPU 101 generates an image data expressing a reduced image to fit in a one-page area using image reduction part 208. FIG. 7(b) illustrates an image formed by reducing the 90 degrees rotated image to fit in a one-page area. FIG. 7(c) illustrates an image formed by being reduced to a size that can fit into a one-page area without rotation.

As described above, according to the present embodiment, in a so-called continuous page copying process, in which images are separately formed for each of the horizontally or vertically juxtaposed pages of a spread manuscript, if there is a component allocated to span the juxtaposed pages, the image of the spread manuscript can be formed without splitting.

The image can also be formed by being reduced to a size fitting into a one-page area. Further, the image can also be formed by being reduced to a size that can fit into a one-page area, after being rotated by 90 degrees.

Since the apparatus separately forms images for the horizontally (or vertically) juxtaposed pages, when a ratio of the width (or height) of a part, belonging to either page, of the component spanning the juxtaposed pages relative to the page width (or page height) is less than a predetermined threshold value, needless rotation or reduction processes can be dispensed with when the component can be split without resulting in any problems.

Also, since the apparatus separately forms images for the horizontally (or vertically) juxtaposed pages, when the width (or height) of a part, belonging to either page of the component spanning the juxtaposed pages is less than a predetermined threshold value, needless rotation or reduction processes can be dispensed with when the component can be split without resulting in any problems.

The present invention can be implemented with various modifications, as exemplified in the following.

While, in the above-described embodiment, the image of the spread manuscript is reduced to a size that can fit into a one-page area with or without 90 degrees rotation, when the image of the spread manuscript is not split, it is possible to form the image on a two-page sized sheet. For example, if the manuscript is of A4 size prescribed in JIS (Japanese Industrial Standards), an image of the spread manuscript can be formed on an A3 size sheet without reduction.

While, in the above-described embodiment, the image is formed using printer (processing part) 111 according to a continuous copying method decided by continuous copying method decision part 206, the image can be processed to be stored in image storage part 117 as an image data expressing the image. In this case, image forming apparatus 10 functions as an electronic filing apparatus. Also, image storage part 117 can be formed as a storage part that is connected to image forming apparatus 10 through network 113.

While, in the above-described embodiment, processes of step S03 and step S04 are performed in parallel, these can be performed sequentially in the order of step S03 and step S04.

While, in the above-described embodiment, CPU 101 executes the program to perform the processing, image forming apparatus 10 can be constructed by hardware parts equipped with an equivalent function.

An image forming apparatus may be constructed to comprise: an image reading reader that reads a manuscript and generating a manuscript image data; an image processor that performs a predetermined processing of an image data; a command input part that inputs a command; an image splitting part that generates split image data expressing two horizontally or vertically split images of the image expressed by the manuscript image data, and supplying the split image data to the processing part; a component extraction part that analyzes a layout of an image expressed by the manuscript image data, and extracting a component of the image; and a controller that, when a command is inputted through the command input part to separately form images of horizontally or vertically juxtaposed pages of a spread manuscript, if the component is allocated to span the horizontally or vertically juxtaposed pages, supplies the manuscript image data to the image processor without splitting, and if the component is not allocated to span the horizontally or vertically juxtaposed pages, supplies is the manuscript image data to the image splitting part.

In the above-described image forming apparatus, a controller, when a command is inputted through the command input part to separately form images of horizontally or vertically juxtaposed pages of a spread manuscript, if the component is allocated to span the horizontally or vertically juxtaposed pages, supplies the manuscript image data to the image processor without splitting, and if the component is not allocated to span the horizontally or vertically juxtaposed pages, supplies the manuscript image data to the image splitting part. The image splitting part generates split image data expressing two horizontally or vertically split images of the image expressed by the manuscript image data, and supplying the split image data to the image processor. The image processor prints an image based on an image data and stores an image data.

Further, an aspect of the present invention provides an image forming method comprising: reading a manuscript and generating manuscript image data; analyzing a layout of an image expressed by the manuscript image data, and extracting a component of the image; and processing the manuscript image data in a predetermined way after generating split image data expressing two horizontally or vertically split images of the image expressed by the manuscript image data if there is not a component allocated to span horizontally or vertically juxtaposed pages among the extracted components, when a command is inputted to separately form images of the horizontally of vertically juxtaposed pages of a spread manuscript.

An aspect of the present invention further provides a continuous copying method decision part for performing a function, the function comprising: reading a manuscript and generating manuscript image data; analyzing a layout of an image expressed by the manuscript image data, and extracting a component of the image; and processing the manuscript image data in a predetermined way after generating split image data expressing two horizontally or vertically split images of the image expressed by the manuscript image data if there is not a component allocated to span horizontally or vertically juxtaposed pages among the extracted components, when a command is inputted to separately form images of the horizontally of vertically juxtaposed pages of a spread manuscript.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, to thereby enable others skilled in the art to understand the invention with various embodiments and modifications as are suited to the particular use contemplated. It is intended that the scope of the invention be defined by the following claims and their equivalents.

The entire disclosure of Japanese Patent Application No. 2004-118248 filed on Apr. 13, 2004 including specifications, claims, drawings and abstract is incorporated herein by reference in its entirety.

1. An image forming apparatus comprising:
an image reader that reads a manuscript and generating manuscript image data;
an image processor that performs a predetermined processing of image data
a command input part that inputs a command;
an image splitting part that generates split image data expressing two horizontally or vertically split images of the image expressed by the manuscript image data, and supplying the split image data to the image processor;
a component extraction part that analyzes a layout of an image expressed by the manuscript image data, and extracting a component of the image; and
a controller that, when a command is inputted through the command input part to separately form images of horizontally or vertically juxtaposed pages of a spread manuscript, if the component is allocated to span the horizontally or vertically juxtaposed pages, supplies the manuscript image data to the image processor without splitting; if the component is not allocated to span the horizontally or vertically juxtaposed pages, supplies the manuscript image data to the image splitting part.

2. The image forming apparatus according to claim 1, wherein the controller generates image data expressing an image formed by reducing a source image to fit into a one-page area, when the component is allocated to span the horizontally or vertically juxtaposed pages and a command for forming a reduced image of the source image is inputted through the command input part.

3. The image forming apparatus according to claim 2, wherein the controller generates an image data expressing an image formed by rotating an image expressed by the manuscript image data by 90 degrees and further generates image data expressing an image formed by reducing the rotated image to fit into a one-page area, when the component is allocated to span the horizontally or vertically juxtaposed pages and a command for forming an image of the source image is inputted through the command input part.

4. The image forming apparatus according to claim 1, wherein the component extraction part comprises:
a line segment extraction part that generates line segment image data by extracting a pixel constituting a line segment from the manuscript image data;
a layout analysis part that analyzes a layout of the line segment image expressed by the line segment image data and categorizing the component into a text area comprising a character string, a line drawing area comprising a line drawing, and a table area comprising a table; and
a picture/photograph extraction part that generates a line segment eliminated image data by eliminating the text area, line drawing area, and table area from the manuscript image data, and extracting a picture/photograph area from the line segment eliminated image data.

5. The image forming apparatus according to claim 1, wherein the controller supplies the manuscript image data to the image splitting part when the component is allocated to span the horizontally juxtaposed pages and a ratio of the width of a part, belonging to either page, of the component spanning the juxtaposed pages relative to the page width is less than a predetermined threshold value.

6. The image forming apparatus according to claim 1, wherein the controller supplies the manuscript image data to the image splitting part when the component is allocated to span the vertically juxtaposed pages and a ratio of the height of a part, belonging to either page, of the component spanning the juxtaposed pages relative to the page height is less than a predetermined threshold value.

7. The image forming apparatus according to claim 1, wherein the controller supplies the manuscript image data to the image splitting part when the component is allocated to span the horizontally juxtaposed pages and a width of a part, belonging to either page, of the component spanning the juxtaposed pages is less than a predetermined threshold value.

8. The image forming apparatus according to claim 1, wherein the controller supplies the manuscript image data to the image splitting part when the component is allocated to span the vertically juxtaposed pages and a height of a part, belonging to either page, of the component spanning the juxtaposed pages is less than a predetermined threshold value.

9. The image forming apparatus according to claim 1, wherein the controller supplies the manuscript image data to the image splitting part when the component is allocated to span the horizontally juxtaposed pages and a width of the component spanning the juxtaposed pages is less than a predetermined threshold value.

10. The image forming apparatus according to claim 1, wherein the controller supplies the manuscript image data to the image splitting part when the component is allocated to span the vertically juxtaposed pages and a height of the component spanning the juxtaposed pages is less than a predetermined threshold value.

11. The image forming apparatus according to claim 1, wherein the image processor comprises a printing part that prints an image based on an image data.

12. The image forming apparatus according to claim 1, wherein the image processor comprises a memory that stores an image data.

13. An image forming method comprising:
reading a manuscript and generating manuscript image data;
analyzing a layout of an image expressed by the manuscript image data, and extracting a component of the image; and
processing the manuscript image data in a predetermined way after generating split image data expressing two horizontally or vertically split images of the image expressed by the manuscript image data if there is not a component allocated to span horizontally or vertically juxtaposed pages among the extracted components, when a command is inputted to separately form images of the horizontally of vertically juxtaposed pages of a spread manuscript.

14. A storage medium readable by a computer, the storage medium storing a program of instructions executable by the computer for performing a function, the function comprising:
reading a manuscript and generating manuscript image data;
analyzing a layout of an image expressed by the manuscript image data, and extracting a component of the image; and
processing the manuscript image data in a predetermined way after generating split image data expressing two horizontally or vertically split images of the image expressed by the manuscript image data if there is not a component allocated to span horizontally or vertically juxtaposed pages among the extracted components, when a command is inputted to separately form images of the horizontally of vertically juxtaposed pages of a spread manuscript.
